(19) United States
(12) Patent Application Publication
(10) Pub. No.: US 2004/0145718 A1
(43) Pub. Date: Jul. 29, 2004

(54) Pad coating system and interlock method thereof

(76) Inventors: Soo-Min Byun, Yongin-city (KR); Byoung-Joo Kim, Hwaseong-gun (KR); In-Seok Hwang, Hwaseong-gun (KR)

Correspondence Address: VOLENTINE FRANCOS, P.L.L.C., Suite 150, 12200 Sunrise Valley Drive, Reston, VA, 20191, US

(21) Appl. No.: 10/757,411

(22) Filed: Jan. 15, 2004

(30) Foreign Application Priority Data
Jan. 16, 2003 (KR) 2003-3091

(51) Int. Cl. G03B 1/00

(52) U.S. Cl. 355/133

(57) ABSTRACT

A pad coating system includes an ultraviolet (UV) source portion which includes first control switches and which irradiates UV light during a pad coating operation in response to a UV source open/close signal, a dispenser which includes second control switches and which dispenses a coating liquid during the pad coating operation in response to a coating condition designation signal, and a prober which generates the UV source open/close signal and the coating condition designation signal and which controls the pad coating operation. The operational states of the first and second switches are monitored, and the pad coating operation is stopped if the operational state of at least one of the first and second switches is not set to a desired state.

### BACKGROUND OF THE INVENTION

1. Field of the Invention

The present invention relates to a pad coating system, and more particularly, the present invention relates to a chip pad coating system and to an interlock method thereof that generates an interrupt signal when an error occurs.

A claim priority under 35 U.S.C. § 119 is made to Korean Patent Application 2003-3091 filed on Jan. 16, 2002, the entire contents of which are hereby incorporated by reference.

2. Description of Related Art

A wafer having fabricated chips is typically tested by applying address and clock test signals from the test pins of a test device to address and clock chip pads of the chips on the wafer. The test signals are simultaneously applied to the chip pads of multiple chips on the wafer.

Generally, due to limitations in the fabrication process, the chips located adjacent an edge of the wafer are incomplete and non-functional. As a result, a short circuit may exist between the address and clock chip pads of the incomplete chips, which in turn can create a problem when the address and clock test signals are commonly applied to the chip pads of the incomplete chip and the chip pads of a chip adjacent to the incomplete chip. That is, when the address and clock test signals are applied to the shorted chip pads of the incomplete chip, a problem can arise in which incorrect test signals are applied to the chip pads of a chip located adjacent the incomplete chip. For example, when an address signal of a “high” level is applied from the test device to a shorted address chip pad of an incomplete chip, an address signal of a “high” level may not be correctly applied to the corresponding address chip pad of a chip which is located adjacent to the incomplete chip.

Accordingly, prior to testing the wafer, a pad coating system is used to coat the address and clock signal chip pads of incomplete chips located at the edge portion of the wafer. The chip pads are coated with an insulating material to prevent electrical contact with the test pins of the test device.

FIG. 1 is a block diagram illustrating a conventional pad coating system. The pad coating system of FIG. I includes a prober 10 having a controller 12, an input/output portion 20, a UV (ultraviolet) source portion 22, and a dispenser 24.

The input/output portion 20 receives data from and outputs data to a controller 12. The controller 12, which is embedded in the prober 10, stores data inputted by the input/output portion 20, controls the prober 10, the UV source portion 22 and the dispenser 24, and outputs data to the input/output portion 20. The prober 10 loads a wafer under control of the controller 12 for coating of a pad identified according to a coordinate value set by the controller 12, and unloads the wafer. The dispenser 24 is responsive to a coating condition designation signal ADD for dispensing of a liquid coating material onto the pad, and the UV source portion 22 is responsive to a shutter open/close signal SOC for controlling the opening and closing of a UV shutter to irradiate UV radiation onto the coating liquid. That is, the coating material is applied as a liquid from the dispenser 24, and then cured into a solid by the UV radiation from the UV source portion 22. In operation, the controller 12 controls the prober 10 and outputs the shutter open/close signal SOC and a coating condition designation signal ADD to the UV source portion 22 and the dispenser 24, respectively.

The UV source portion 62 includes a UV shutter switch 1, a time/manual mode switch 2, and a UV lamp switch 3.

When the UV shutter switch 1 is set to open, a shutter is open to enable the UV source portion 22 to emit UV irradiation. When the UV shutter switch 1 is closed, the shutter is closed and no UV irradiation is enabled.

When the time/manual mode switch 2 is set to time mode, the duration of UV irradiation is automatically controlled by the shutter open/close signal SOC applied from the controller 12. When the time/manual mode switch 2 is set to manual mode, the duration of UV irradiation is manually controlled by the operator.

When the UV lamp switch 3 is on, a UV lamp is sufficiently heated to emit UV irradiation. When the lamp switch 3 is not on, the UV lamp does not emit UV irradiation.

The dispenser 24 is a device which controls pad coating conditions such as a coating liquid amount, an injection pressure, and an injection time. The dispenser 24 includes internal/external mode switch 4 and a time/manual mode switch 5.

When the internal/external mode switch 4 is in an internal mode, pad coating conditions of the dispenser 24 are set manually by the operator or internally by the dispenser. When the internal/external mode switch is in an external mode, the pad coating conditions are set by the coating condition designation signal ADD applied from the controller 12.

When the time/manual mode switch 5 is set to the time mode, an injection time is automatically set by the controller 12. When the time/manual mode switch is set to the manual mode, an injection time is manually controlled by the user.

In the conventional pad coating system, operational errors can arise which adversely effect the coating operation. For example, the operator may inadvertently set the time/manual mode 2 to the manual mode, in which case the UV irradiation time may not be correctly adjusted. Also, the shutter open/close switch 1 may not open properly, or the UV lamp switch 3 may not properly turn on. Any of these errors will result in improper UV irradiation, which in turn can result in faulty coating of the chip pads.

Likewise, the operator may inadvertently set the internal/external mode switch 4 to the internal mode, and/or the time/manual switch 5 to the manual mode. In either case, an improper dispensing of coating material can result.

### SUMMARY OF THE INVENTION

It is an object of the present invention to provide a pad coating system which monitors states an UV source portion and a dispenser and then stops a pad coating operation when the UV source portion and the dispenser are not set to a desired state.

It is another object of the present invention to provide an interlock method of a pad coating system which monitors states of an UV source portion and a dispenser and then stops a pad coating operation when the UV source portion and the dispenser are not set to a desired state.

According to an aspect of the present invention, a pad coating system is provided which includes an ultraviolet (UV) source portion, a dispenser, and a prober. The UV source portion includes first control switches, irradiates UV light during a pad coating operation in response to a UV source open/close signal, and outputs first signals indicative of respective operative states of the the first control switches. The dispenser includes second control switches, dispenses a coating liquid during the pad coating operation in response to a coating condition designation signal, and outputs second signals indicative of respective operative states of the second control switches. The prober generates the UV source open/close signal and the coating condition designation signal, controls the pad coating operation, and stops the pad coating operation in response to the first and second signals.

According to another aspect of the present invention, a interlock method for a pad coating system is provided, where the pad coating system includes an ultraviolet (UV) source portion which includes first control switches and which irradiates UV light during a pad coating operation in response to a UV source open/close signal, a dispenser which includes second control switches and which dispenses a coating liquid during the pad coating operation in response to a coating condition designation signal, and a prober which generates the UV source open/close signal and the coating condition designation signal and which controls the pad coating operation. The method includes monitoring operational states of the first and second switches, and stopping the pad coating operation when the operational state of at least one of the first and second switches is not set to a desired state.

### BRIEF DESCRIPTION OF THE DRAWINGS

For a more complete understanding of the present invention and the advantages thereof, reference is now made to the following description taken in conjunction with the accompanying drawings, in which like reference numerals denote like parts, and in which:

FIG. 1 is a block diagram illustrating a conventional pad coating system;

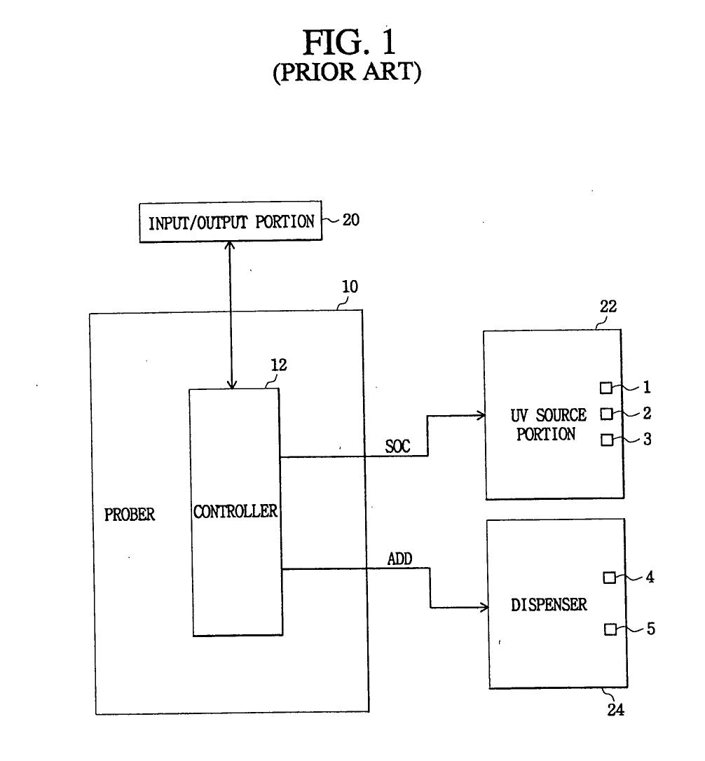

FIG. 2 is a block diagram illustrating a pad coating system according to an embodiment of the present invention;

FIG. 3 is a block diagram illustrating a pad coating system according to another embodiment of the present invention; and

FIG. 4 is a flow chart illustrating an interlock method of a pad coating system according to the present invention.

### DETAILED DESCRIPTION OF PREFFERED EMBODIMENTS

Reference will now be made in detail to preferred embodiments of the present invention, examples of which are illustrated in the accompanying drawings.

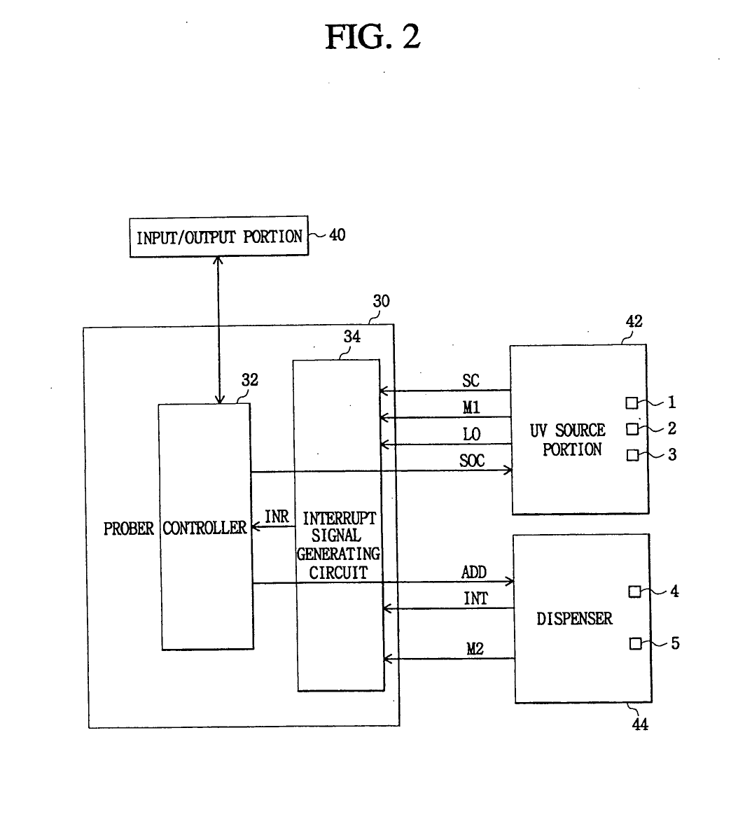

FIG. 2 is a block diagram illustrating a pad coating system according to an embodiment of the present invention. The pad coating system of FIG. 2 includes a prober 30, an input/output portion 40, a UV source portion 42, and a dispenser 44. The prober 30 includes a controller 32 and an interrupt signal generating circuit 34.

The input/output portion 40 receives data from and outputs data to the controller 32. The controller 32, which is embedded in the prober 30, stores data inputted by the input/output portion 40, controls the prober 30, the UV source portion 42 and the dispenser 44, and outputs data to the input/output portion 40. That is, the controller 32 outputs a shutter open/close signal SOC and a coating condition designation signal ADD to the UV source portion 42 and the dispenser 44, respectively, and stops an operation of the system in response to an interrupt signal INR.

The prober 30 loads a wafer under a control of the controller 32, coats the pad while searching the pad according to a coordinate value set by the controller 32, and unloads the wafer.

The interrupt signal generating circuit 34 generates a interrupt signal INR in accordance with a shutter close signal SC, a manual mode signal M1, a UV lamp off signal LO, an interior mode signal INT and a manual mode signal M2. The shutter close signal SC, the manual mode signal M1, the UV lamp off signal LO are generated by the UV source portion 42, and the interior mode signal INT and the manual mode signal M2 are generated by the dispenser 44. In the embodiment, the shutter close signal SC is “high” when the shutter open/close switch 1 is in a close state; the manual mode signal M1 is “high” when the time/manual mode switch 2 of the UV source portion 42 is in a manual mode; the UV lamp off signal LO is “high” when the UV lamp 3 of the UV source portion 42 is in an off state; the interior mode signal INT is “high” when the interior/exterior mode switch 4 of the dispenser 44 is in an interior mode; and the manual mode signal M2 is “high” when the time/manual mode switch 5 of the dispenser 44 is in a manual mode. If any one or more of these signals SC, M1, LO, INT, and M2 has a “high” level, the interrupt signal generating circuit 34 generates an interrupt signal INR. In-response, the controller 32 generates an alarm or outputs an error message through the input/output portion 40.

The UV source portion 42 opens or closes the UV shutter in response to the shutter open/close signal SOC applied from the controller 32, and outputs the shutter close signal SC that represents whether the shutter open/close switch 1 is in the close state, the manual mode signal M1 that represents whether the time/manual mode switch 2 is in a manual mode, and the UV lamp off signal LO that represents whether the UV lamp 3 is in an off state.

The dispenser 44 injects a coating liquid in response to the coating condition designation signal ADD applied from the controller 32, and outputs the interior mode signal INT that represents whether the interior/exterior mode switch 4 is in an interior mode and the manual mode signal M2 that represents whether the time/manual mode switch 5 is in a manual mode.

As noted above, the pad coating system generates an interrupt signal INR to stop the coating operation when the shutter open/close switch 1 of the UV source portion 42 is set to the close state, the time/manual mode switch 2 is set to the manual mode, the UV lamp is set to an off state, the interior/exterior mode switch 4 of the dispenser 44 is set to an interior mode, or the time/manual mode switch 5 is set to a manual mode. When the interrupt signal INR is generated, an alarm is generated or the error message is output through the input/output portion 40. As such, an operator can alerted to check the switches of the UV source portion 42 and the dispenser 44 to remove source of the error, thereby preventing a faulty pad coating operation in advance.

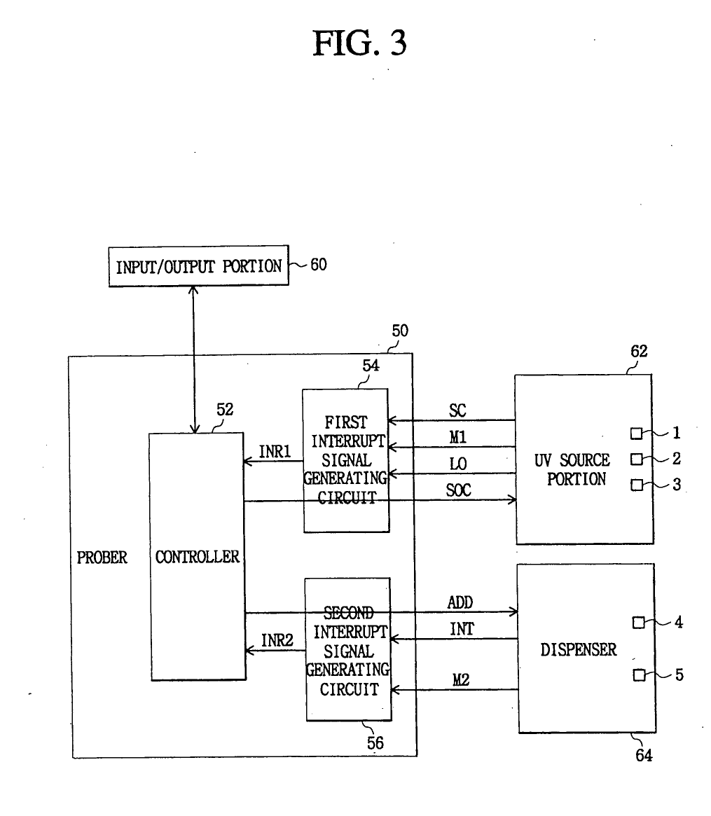

FIG. 3 is a block diagram illustrating a pad coating system according to another embodiment of the present invention. The pad coating system of FIG. 3 includes a prober 50, an input/output portion 60, a UV source portion 62, and a dispenser 64. The prober 50 includes a controller 52 and a first and second interrupt signal generating circuit 54 and 56.

The first interrupt signal generating circuit 54 generates a first interrupt signal INR1 in accordance with a shutter close signal SC, a manual mode signal M1, and a UV lamp off signal LO which are generated by the UV source portion 62. In this embodiment, the shutter close signal SC is “high” when the shutter open/close switch 1 of the UV source portion 62 is in a closed state; the manual mode signal M1 is “high” when the time/manual mode switch 2 of the UV source portion 62 is in a manual mode; and the UV lamp off signal LO is “high” when the UV lamp 3 of the UV source portion 62 is in an off state. The first interrupt signal generating circuit 54 generates a first interrupt signal INR1 when one or more of these signals SC, M1 and LO have a “high” level.

The second interrupt signal generating circuit 56 generates a second interrupt signal INR2 in accordance with an interior mode signal INT and a manual mode signal M2 which are generated by the dispenser 64. In this embodiment, the interior mode signal INT is “high” the interior/exterior mode switch 4 of the dispenser 64 is in an interior mode, and the manual mode signal M2 is “high” the time/manual mode switch 5 of the dispenser 64 is in a manual. The second interrupt signal generating circuit 56 generates a second interrupt signal INR2 when one or more of these signals INT and M2 have a “high” level.

The controller 52 generates an alarm or output an error message through the input/output portion 60 when the first interrupt signal INR1 or the second interrupt signal INR2 is generated. Also, at the time of outputting an error message, the controller outputs a message that indicates an error related to the UV source portion 62 when the first interrupt signal INR1 is generated, and the controller and outputs a message that indicates an error related to the dispenser 64 when the second interrupt signal INR2 is generated.

The pad coating system of FIG. 3 allows for the visual display, via the input/output portion 60, of whether an error relates to the UV source portion 54 or to the dispenser 64, and thus an operator can easily determine the source of the error.

Even though not shown, the first and second interrupt signal generating circuits 54 and 56 can be, respectively, arranged in the UV source portion 62 and the dispenser 64, rather than in the prober 50.

Also, the interrupt signal generating circuit 34 of FIG. 2 and the first and second interrupt signal generating circuits 54 and 56 can not omitted. In this case, the pad coating system is configured such that the signals SC, M1 and LO generated from the UV source portion 62 and the signals INT and M2 generated from the dispenser 64 are directly applied to the controller. The controller is then programmed to determined the existence of an error according to the state of the respective signals SC, M1, LO, INT, and M2. As before, any error can be visually displayed via the input/output portion.

In FIGS. 2 and 3, without requiring an additional circuit to generate the signals SC, M1 and LO, the UV source portion can be configured such that the signals internally generated by a manipulation of the switches 1, 2 and 3 are externally outputted. Similarly, without requiring an additional circuit to generate the signals INT and M2, the dispenser can be configured such that the signals internally generated are externally outputted by a manipulation of the switches 4 and 5.

The pad coating system of the present invention stops a pad coating operation when the switches of the UV source portion and the dispenser are not set to a desired state, that is, in a state where the UV source portion and the dispenser can not be fully controlled by the controller.

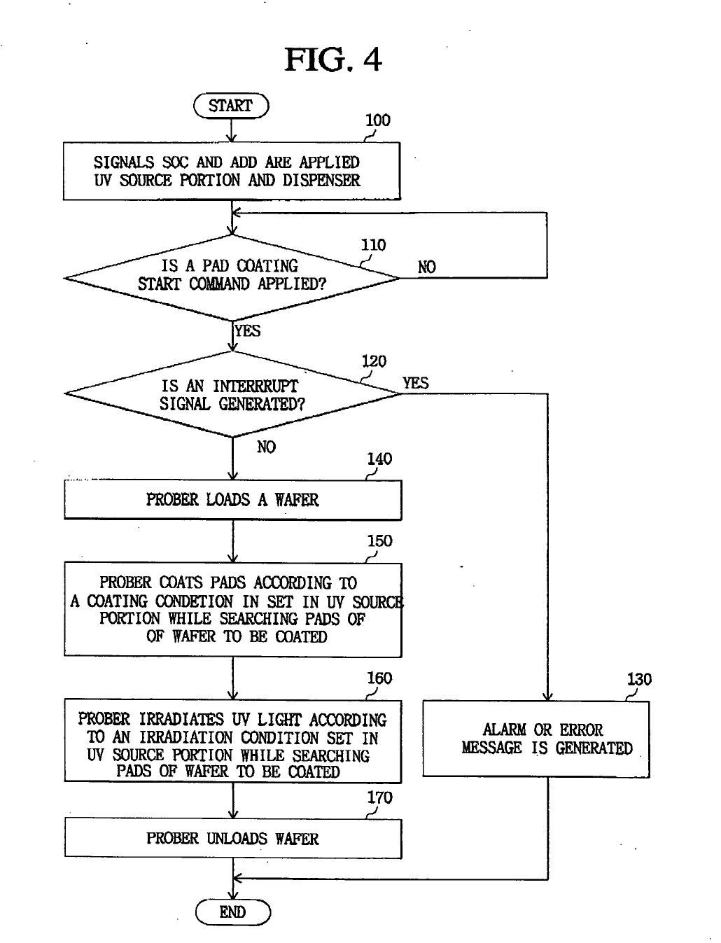

FIG. 4 is a flow chart illustrating an interlock method of the pad coating system of the present invention. The flow chart of FIG. 4 shows an interlock method for a single of wafer.

First, the controller outputs the shutter open/close signal SOC and the coating condition designation signal ADD to the UV source portion and the dispenser, respectively (step 100).

The controller then determines whether a pad coating start command is applied (step 110). If not, step 110 is performed again.

If the pad coating start command is applied, it is determined whether the interrupt signal INR has been generated (step 120).

If the interrupt signal INR has been generated, an alarm or an error message is generated through the input/output portion (step 130). That is, before performing a pad coating operation, the controller determines whether the switches of the UV source portion and the dispenser have been set to a desired state. If the switches are not set to a desired state, the controller stops a pad coating operation. As described above, the interrupt signal INR is generated when the shutter open/close switch is in a close state, the time/manual mode switch is in a manual mode state, the UV lamp is in an off state, the internal/external mode switch of the dispenser is in an internal mode state, or the time/manual mode switch is in a manual mode.

If the interrupt signal INR is not generated, the prober loads a wafer to perform a pad coating operation (step 140).

The prober coats the pads according to a coating condition set in the dispenser while searching for the pads of the wafer to be coated (step 150).

Next, the prober irradiates the UV light according to a condition set in the UV source portion while searching for the pads of the wafer to be coated (step 160).

In steps 150 and 160, the prober searches for the pads of the wafer to be coated according to a coordinate value set in the controller.

Lastly, the prober unloads the completed wafer and ends its operation (step 170).

Even though an interlock method of FIG. 4 checks whether the interrupt signal INR is generated in one wafer unit, it is possible to check whether an interrupt signal INR is generated in plural wafer units.

As described herein before, the pad coating system and the interlock method according to the present invention can prevent malfuntions in advance by stopping a pad coating operation when the switches of the UV source portion and the dispenser are not set to a desired state.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A pad coating system, comprising:
an ultraviolet (UV) source portion which includes first control switches, which irradiates UV light during a pad coating operation in response to a UV source open/close signal, and which outputs first signals indicative of respective operative states of the the first control switches;
a dispenser which includes second control switches, which dispenses a coating liquid during the pad coating operation in response to a coating condition designation signal, and which output second signals indicative of respective operative states of the second control switches; and
a prober which generates the UV source open/close signal and the coating condition designation signal, which controls the pad coating operation, and which stops the pad coating operation in response to the first and second signals.

2. The system of claim 1, wherein the prober comprises an interrupt signal generating circuit which generates an interrupt signal in response to the first and second signals, and controller which stops the pad coating operation in response to the interrupt signal.

3. The system of claim 2, wherein the pad coating system further comprises an input/output portion, which transmits and receives data to and from the controller.

4. The system of claim 1, wherein the prober comprises a first interrupt signal generating circuit which generates a first interrupt signal in response to the first signals, a second interrupt signal generating circuit which generates a second interrupt signal in response to the second signals, and controller which stops the pad coating operation in response to the first and second interrupt signals.

5. The system of claim 1, wherein the first control switches include a shutter open/close switch which opens and closes a shutter to enable UV irradition, a time/manual mode switch which sets a UV irradiation time either automatically or manually, and a UV lamp switch turns on and off a UV lamp.

6. The system of claim 1, wherein the second switches include an internal/external mode switch which sets pad coating conditions either automically or manually, and a time/manual mode switch which sets a coating time either automatically or manually.

7. An interlock method for a pad coating system, the pad coating system including an ultraviolet (UV) source portion which includes first control switches and which irradiates UV light during a pad coating operation in response to a UV source open/close signal, a dispenser which includes second control switches and which dispenses a coating liquid during the pad coating operation in response to a coating condition designation signal, and a prober which generates the UV source open/close signal and the coating condition designation signal and which controls the pad coating operation, said method comprising:
monitoring operational states of the the first and second switches; and
stopping the pad coating operation when the operational state of at least one of the first and second switches is not set to a desired state.

8. The method of claim 7, further comprising:
outputting first signals indicative of respective operational states of the the first control switches;
outputting second signals indicative of respective operational states of the second control switches;
generating an interrupt signal in accordance with the first and second signals; and
stopping the pad coating operation and generating at least one of an alarm and error message in response to the interrup signal.

9. The method of claim 7, further comprising:
outputting first signals indicative of respective operational states of the the first control switches;
outputting second signals indicative of respective operational states of the second control switches;
generating a first interrupt signal in accordance with the first signals and a second interrupt signal in accordance with the second signals; and
stopping the pad coating operation and generating at least one of an alarm and error message in response to the first and second interrup signals.

10. The method of claim 7, wherein the first control switches include a shutter open/close switch which opens and closes a shutter to enable UV irradition, a time/manual mode switch which sets a UV irradiation time either automatically or manually, and a UV lamp switch turns on and off a UV lamp.

11. The system of claim 7, wherein the second switches include an internal/external mode switch which sets pad coating conditions either automically or manually, and a time/manual mode switch which sets a coating time either automatically or manually.
